(19) United States
(12) Patent Application Publication
(10) Pub. No.: US 2024/0155461 A1
(43) Pub. Date: May 9, 2024

(54) COMMUNICATION CONTROL METHOD

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 18/410,545

(22) Filed: Jan. 11, 2024

Related U.S. Application Data
(63) Continuation of application No. PCT/JP2022/026942, filed on Jul. 7, 2022.

(30) Foreign Application Priority Data
Jul. 12, 2021 (JP) 2021-115335

(51) Int. Cl. H04W 40/22

(52) U.S. Cl. CPC H04W 40/22; H04W 88/04

(57) ABSTRACT

In a first aspect, a communication control method is used in a cellular communication system. The communication control method includes performing, by a donor node for each of a first user equipment and a second user equipment, configuration to establish a data radio bearer (DRB) between the first user equipment and the second user equipment. The communication control method includes establishing, by the first user equipment and the second user equipment, a first Packet Data Convergence Protocol (PDCP) entity and a second PDCP entity, respectively, in response to receiving the configuration. The communication control method includes transmitting, by the first PDCP entity, data to the second PDCP entity without involving a User Plane Function (UPF).

### RELATED APPLICATIONS

The present application is a continuation based on PCT Application No. PCT/JP2022/026942, filed on Jul. 7, 2022, which claims the benefit of Japanese Patent Application No. 2021-115335 filed on Jul. 12, 2021. The content of which is incorporated by reference herein in their entirety.

### TECHNICAL FIELD

The present disclosure relates to a communication control method used in a cellular communication system.

### BACKGROUND OF INVENTION

In the Third Generation Partnership Project (3GPP), which is a project for the standardization of cellular communication systems, introducing a new relay node referred to as an Integrated Access and Backhaul (IAB) node (for example, see “3GPP TS 38.300 V16.5.0 (2021-03)”) is being considered. One or more relay nodes are involved in communication between a base station and a user equipment and perform relay for the communication.

### SUMMARY

In a first aspect, a communication control method is used in a cellular communication system. The communication control method includes performing, by a donor node for each of a first user equipment and a second user equipment, configuration to establish a data radio bearer (DRB) between the first user equipment and the second user equipment. The communication control method includes establishing, by the first user equipment and the second user equipment, a first Packet Data Convergence Protocol (PDCP) entity and a second PDCP entity, respectively, in response to receiving the configuration. The communication control method further includes: transmitting, by the first PDCP entity, data to the second PDCP entity without involving a user plane function (UPF); and relaying, by the relay node, the data through Layer2 Relay in a layer lower than the PDCP layer.

In a second aspect, a communication control method is used in a cellular communication system. The communication control method includes performing, by a donor node, routing configuration for a relay node configured to perform local routing. The communication control method includes transmitting, by a relay node, data transmitted from a first user equipment to a second user equipment without involving a UPF in accordance with the routing configuration.

In a third aspect, a communication control method is used in a cellular communication system. The communication control method includes transmitting, by a relay node, data transmitted from a first user equipment to a second user equipment without involving a UPF in accordance with routing configuration. The communication control method includes transmitting, by the relay node, a data amount of the data to a donor node.

### BRIEF DESCRIPTION OF THE DRAWINGS

FIG. 1 is a diagram illustrating a configuration example of a cellular communication system according to an embodiment.

FIG. 2 is a diagram illustrating a relationship between an IAB node, parent nodes, and child nodes according to an embodiment.

FIG. 3 is a diagram illustrating a configuration example of a gNB (donor node) according to an embodiment.

FIG. 4 is a diagram illustrating a configuration example of an IAB node (relay node) according to an embodiment.

FIG. 5 is a diagram illustrating a configuration example of a UE (user equipment) according to an embodiment.

FIG. 6 is a diagram illustrating an example of a protocol stack related to a Radio Resource Control (RRC) connection and a Non-Access Stratum (NAS) connection of an IAB-MT according to an embodiment.

FIG. 7 is a diagram illustrating an example of a protocol stack related to an F1-U protocol according to an embodiment.

FIG. 8 is a diagram illustrating an example of a protocol stack related to an F1-C protocol according to an embodiment.

FIGS. 9A and 9B are diagrams illustrating examples of a PDCP link according to a first embodiment.

FIG. 10 is a flowchart illustrating an operation example according to the first embodiment.

FIG. 11 is a flowchart illustrating an operation example according to a second embodiment.

FIGS. 12A and 12B are diagrams illustrating relationship examples of the IAB nodes according to the second embodiment.

FIGS. 13A and 13B are diagrams illustrating examples of Radio Link Control (RLC) channel information according to the second embodiment.

FIG. 14 is a flowchart illustrating an operation example according to a third embodiment.

### DESCRIPTION OF EMBODIMENTS

A cellular communication system in an embodiment is described with reference to the drawings. In the description of the drawings, the same or similar parts are denoted by the same or similar reference signs.

Configuration of Cellular Communication System

First, a configuration example of the cellular communication system in an embodiment is described. In an embodiment, a cellular communication system is a 3GPP 5G system. Specifically, a radio access scheme in the cellular communication system is New Radio (NR) being a 5G radio access scheme. Note that Long Term Evolution (LTE) may be at least partially applied to the cellular communication system. A future cellular communication system such as the 6G may be applied to the cellular communication system 1.

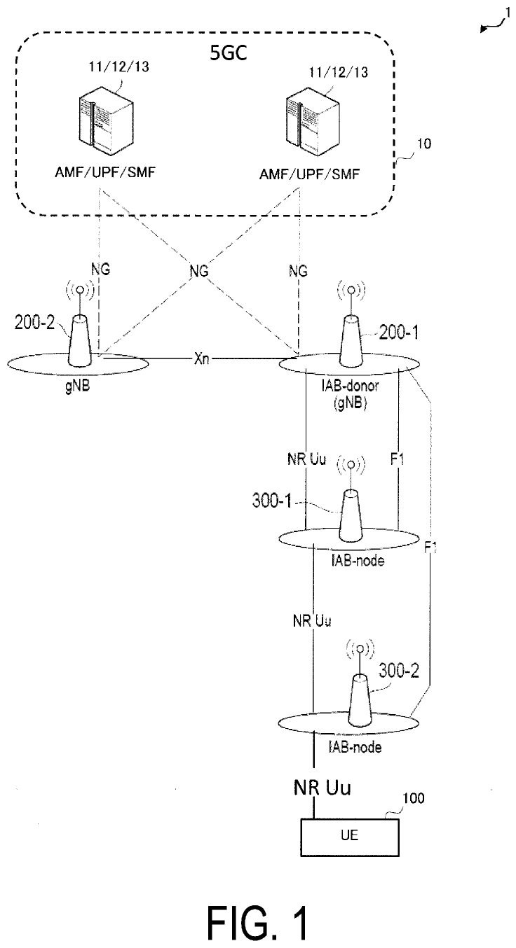

FIG. 1 is a diagram illustrating a configuration example of the cellular communication system 1 according to an embodiment.

As illustrated in FIG. 1, the cellular communication system 1 includes a 5G core network (5GC) 10, a User Equipment (UE) 100, base station apparatuses (hereinafter, also referred to as base stations in some cases) 200-1 and 200-2, and IAB nodes 300-1 and 300-2. The base station 200 may be referred to as a next generation Node B (gNB).

An example in which the base station 200 is an NR base station is mainly described below, but the base station 200 may also be an LTE base station (i.e., an evolved Node B (eNB)).

Note that hereinafter, the base stations 200-1 and 200-2 may be referred to as a gNB 200 (or the base station 200 in some cases), and the IAB nodes 300-1 and 300-2 may be referred to as an IAB node 300.

The 5GC 10 includes an Access and Mobility Management Function (AMF) 11, a User Plane Function (UPF) 12, and a Session Management Function (SMF) 13. The AMF 11 is an apparatus that performs various types of mobility controls and the like for the UE 100. The AMF 11 communicates with the UE 100 by using Non-Access Stratum (NAS) signaling, and thereby manages information of an area in which the UE 100 exists. The UPF 12 is an apparatus that performs transfer control of user data and the like. The SMF 13 is an apparatus that performs session management of the UE 100, control of the UPF 12, and the like.

Each gNB 200 is a fixed wireless communication node and manages one or more cells. The term “cell” is used to indicate a minimum unit of a wireless communication area. The term “cell” may be used to indicate a function or a resource for performing wireless communication with the UE 100. Hereinafter, a “cell” may be used without being distinguished from a base station such as the gNB 200. One cell belongs to one carrier frequency.

Each gNB 200 is interconnected to the 5GC 10 via an interface referred to as an NG interface. FIG. 1 illustrates a gNB 200-1 and a gNB 200-2 that are connected to the 5GC 10.

Each gNB 200 may be divided into a Central Unit (CU) and a Distributed Unit (DU). The CU and the DU are interconnected via an interface referred to as an F1 interface. An F1 protocol is a communication protocol between the CU and the DU and includes an F1-C protocol that is a control plane protocol and an F1-U protocol that is a user plane protocol.

The cellular communication system 1 supports an IAB that uses NR for the backhaul to enable wireless relay of an NR access. The donor gNB (or the donor node, hereinafter also referred to as the “donor node”) 200-1 is a donor base station that is a terminal node of the NR backhaul on the network side and includes additional functionality for supporting the IAB. The backhaul can implement multi-hop via a plurality of hops (i.e., a plurality of IAB nodes 300).

FIG. 1 illustrates an example in which the IAB node 300-1 is wirelessly connected to the donor node 200-1, the IAB node 300-2 is wirelessly connected to the IAB node 300-1, and the F1 protocol is transmitted in two backhaul links.

The UE 100 is a mobile wireless communication apparatus that performs wireless communication with the cells. The UE 100 may be any type of apparatus as long as the UE 100 is an apparatus that performs wireless communication with the gNB 200 or the IAB node 300. For example, the UE 100 includes a mobile phone terminal, or a tablet terminal, a laptop PC, a sensor or an apparatus that is provided in a sensor, a vehicle or an apparatus that is provided in a vehicle, and an aircraft or an apparatus provided in an aircraft. The UE 100 is wirelessly connected to the IAB node 300 or the gNB 200 via an access link FIG. 1 illustrates an example in which the UE 100 is wirelessly connected to the IAB node 300-2. The UE 100 indirectly communicates with the donor node 200-1 via the IAB node 300-2 and the IAB node 300-1. FIG. 1 illustrates an example in which the IAB node 300-2 and the IAB node 300-1 function as relay nodes.

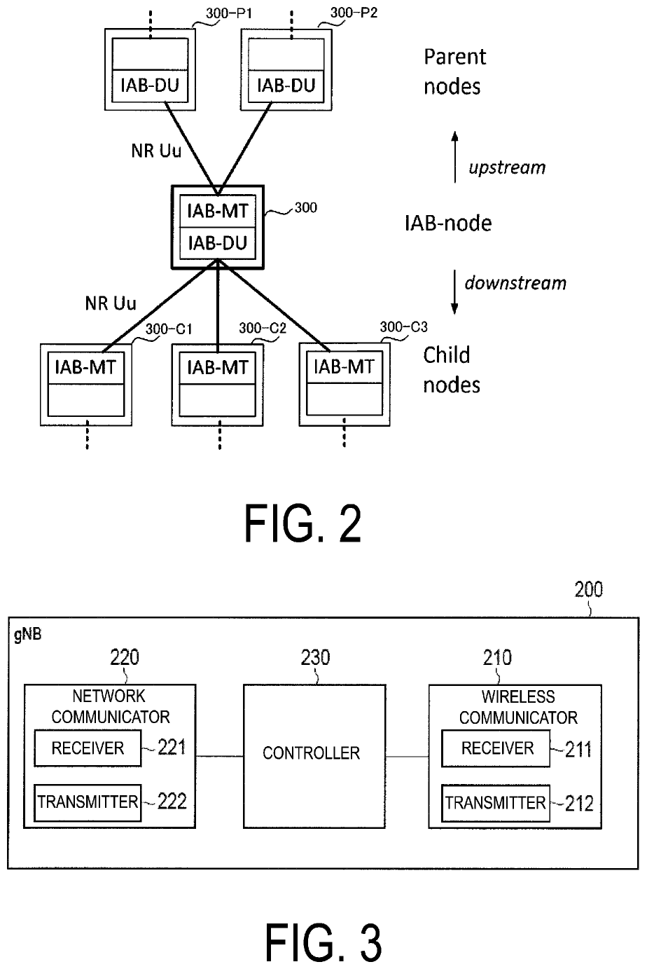

FIG. 2 is a diagram illustrating a relationship between the IAB node 300, parent nodes, and child nodes.

As illustrated in FIG. 2, each IAB node 300 includes an IAB-DU corresponding to a base station functional unit and an IAB-Mobile Termination (MT) corresponding to a user equipment functional unit.

Neighboring nodes of the IAB-MT (i.e., upper node) of an NR Uu wireless interface are referred to as “parent nodes”. The parent node is the DU of a parent IAB node or the donor node 200. A radio link between the IAB-MT and each parent node is referred to as a backhaul link (BH link) FIG. 2 illustrates an example in which the parent nodes of the IAB node 300 are IAB nodes 300-P1 and 300-P2. Note that the direction toward the parent nodes is referred to as upstream. As viewed from the UE 100, the upper nodes of the UE 100 can correspond to the parent nodes.

Neighboring nodes of the IAB-DU (i.e., lower nodes) of an NR access interface are referred to as “child nodes”. The IAB-DU manages cells in a manner the same as, and/or similar to the gNB 200. The IAB-DU terminates the NR Uu wireless interface connected to the UE 100 and the lower IAB nodes. The IAB-DU supports the F1 protocol for the CU of the donor node 200-1. FIG. 2 illustrates an example in which the child nodes of the IAB node 300 are IAB nodes 300-C1 to 300-C3; however, the UE 100 may be included in the child nodes of the IAB node 300. Note that the direction toward the child nodes is referred to as downstream.

All of the IAB nodes 300 connected to the donor node 200 via one or more hops form a Directed Acyclic Graph (DAG) topology (which may be referred to as “topology” below) rooted at the donor node 200. In this topology, the neighboring nodes of the IAB-DU in the interface are child nodes, and the neighboring nodes of the IAB-MT in the interface are parent nodes as illustrated in FIG. 2. The donor node 200 performs, for example, centralized management on resources, topology, and routes of the IAB topology. The donor node 200 is a gNB that provides network access to the UE 100 via a network of backhaul links and access links.

Configuration of Base Station

A configuration of the gNB 200 that is a base station according to the embodiment is described. FIG. 3 is a diagram illustrating a configuration example of the gNB 200. As illustrated in FIG. 3, the gNB 200 includes a wireless communicator 210, a network communicator 220, and a controller 230.

The wireless communicator 210 performs wireless communication with the UE 100 and performs wireless communication with the IAB node 300. The wireless communicator 210 includes a receiver 211 and a transmitter 212. The receiver 211 performs various types of reception under control of the controller 230. The receiver 211 includes an antenna and converts (down-converts) a radio signal received by the antenna into a baseband signal (reception signal) which is then transmitted to the controller 230. The transmitter 212 performs various types of transmission under control of the controller 230. The transmitter 212 includes an antenna and converts (up-converts) the baseband signal (transmission signal) output by the controller 230 into a radio signal which is then transmitted from the antenna.

The network communicator 220 performs wired communication (or wireless communication) with the 5GC 10 and performs wired communication (or wireless communication) with another neighboring gNB 200. The network communicator 220 includes a receiver 221 and a transmitter 222. The receiver 221 performs various types of reception under control of the controller 230. The receiver 221 receives a signal from an external source and outputs the reception signal to the controller 230. The transmitter 222 performs various types of transmission under control of the controller 230. The transmitter 222 transmits the transmission signal output by the controller 230 to an external destination.

The controller 230 performs various types of controls for the gNB 200. The controller 230 includes at least one memory and at least one processor electrically connected to the memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. The processor performs processing of the layers described below. The controller 230 may perform various types of processing in the gNB 200 (or the donor node 200) in each embodiment described below.

Configuration of Relay Node

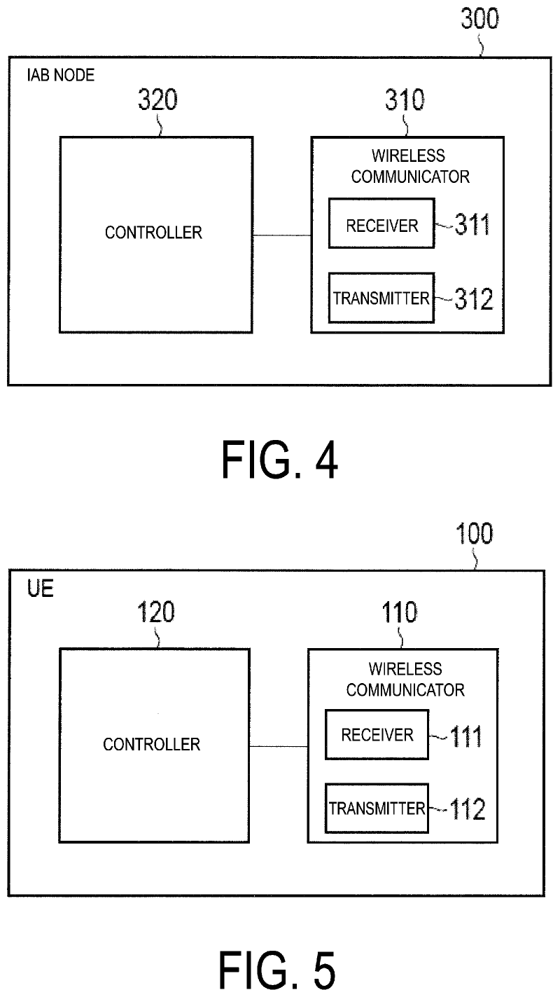

A configuration of the IAB node 300 is described that is a relay node (or a relay node apparatus, which is also referred to as a “relay node” below) in the embodiment. FIG. 4 is a diagram illustrating a configuration example of the IAB node 300. As illustrated in FIG. 4, the IAB node 300 includes a wireless communicator 310 and a controller 320. The IAB node 300 may include a plurality of wireless communicators 310.

The wireless communicator 310 performs wireless communication with the gNB 200 (BH link) and wireless communication with the UE 100 (access link) The wireless communicator 310 for the BH link communication and the wireless communicator 310 for the access link communication may be provided separately.

The wireless communicator 310 includes a receiver 311 and a transmitter 312. The receiver 311 performs various types of reception under control of the controller 320. The receiver 311 includes an antenna and converts (down-converts) a radio signal received by the antenna into a baseband signal (reception signal) which is then transmitted to the controller 320. The transmitter 312 performs various types of transmission under control of the controller 320. The transmitter 312 includes an antenna and converts (up-converts) the baseband signal (transmission signal) output by the controller 320 into a radio signal which is then transmitted from the antenna.

The controller 320 performs various types of controls in the IAB node 300. The controller 320 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of the layers described below. The controller 320 may perform various types of processing in the IAB node 300 in each embodiment described below.

Configuration of User Equipment

A configuration of the UE 100 that is a user equipment according to the embodiment is described next. FIG. 5 is a diagram illustrating a configuration example of the UE 100. As illustrated in FIG. 5, the UE 100 includes a wireless communicator 110 and a controller 120.

The wireless communicator 110 performs wireless communication in the access link, i.e., wireless communication with the gNB 200 and wireless communication with the IAB node 300. The wireless communicator 110 may also perform wireless communication in a sidelink, i.e., wireless communication with another UE 100. The wireless communicator 110 includes a receiver 111 and a transmitter 112. The receiver 111 performs various types of reception under control of the controller 120. The receiver 111 includes an antenna and converts (down-converts) a radio signal received by the antenna into a baseband signal (reception signal) which is then transmitted to the controller 120. The transmitter 112 performs various types of transmission under control of the controller 120. The transmitter 112 includes an antenna and converts (up-converts) the baseband signal (transmission signal) output by the controller 120 into a radio signal which is then transmitted from the antenna.

The controller 120 performs various types of control in the UE 100. The controller 120 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of the layers described below. The controller 120 may perform various types of processing in the UE 100 in each embodiment described below.

Configuration of Protocol Stack

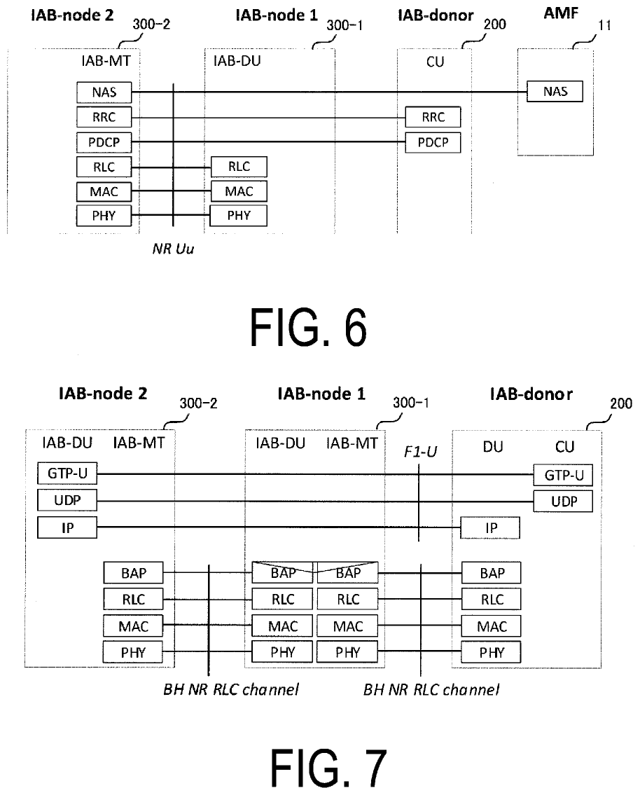

A configuration of a protocol stack according to the embodiment is described next. FIG. 6 is a diagram illustrating an example of a protocol stack related to an RRC connection and a NAS connection of the IAB-MT.

As illustrated in FIG. 6, the IAB-MT of the IAB node 300-2 includes a physical (PHY) layer, a Medium Access Control (MAC) layer, a Radio Link Control (RLC) layer, a Packet Data Convergence Protocol (PDCP) layer, a Radio Resource Control (RRC) layer, and a Non-Access Stratum (NAS) layer.

The PHY layer performs coding and decoding, modulation and demodulation, antenna mapping and demapping, and resource mapping and demapping. Data and control information are transmitted between the PHY layer of the IAB-MT of the IAB node 300-2 and the PHY layer of the IAB-DU of the IAB node 300-1 via a physical channel.

The MAC layer performs priority control of data, retransmission processing through hybrid ARQ (HARQ: Hybrid Automatic Repeat reQuest), a random access procedure, and the like. Data and control information are transmitted between the MAC layer of the IAB-MT of the IAB node 300-2 and the MAC layer of the IAB-DU of the IAB node 300-1 via a transport channel. The MAC layer of the IAB-DU includes a scheduler. The scheduler determines uplink and the downlink transport formats (transport block sizes, Modulation and Coding Schemes (MCSs)) and resource blocks.

The RLC layer transmits data to the RLC layer on the reception side by using functions of the MAC layer and the PHY layer. Data and control information are transmitted between the RLC layer of the IAB-MT of the IAB node 300-2 and the RLC layer of the IAB-DU of the IAB node 300-1 via a logical channel.

The PDCP layer performs header compression and decompression, and encryption and decryption. Data and control information are transmitted between the PDCP layer of the IAB-MT of the IAB node 300-2 and the PDCP layer of the CU of the donor node 200 via a radio bearer.

The RRC layer controls a logical channel, a transport channel, and a physical channel according to establishment, re-establishment, and release of a radio bearer. RRC signaling for various configurations is transmitted between the RRC layer of the IAB-MT of the IAB node 300-2 and the RRC layer of the CU of the donor node 200. When an RRC connection to the donor node 200 is present, the IAB-MT is in an RRC connected state. When no RRC connection to the donor node 200 is present, the IAB-MT is in an RRC idle state.

The NAS layer which is positioned upper than the RRC layer performs session management, mobility management, and the like. NAS signaling is transmitted between the NAS layer of the IAB-MT of the IAB node 300-2 and the NAS layer of the AMF 11.

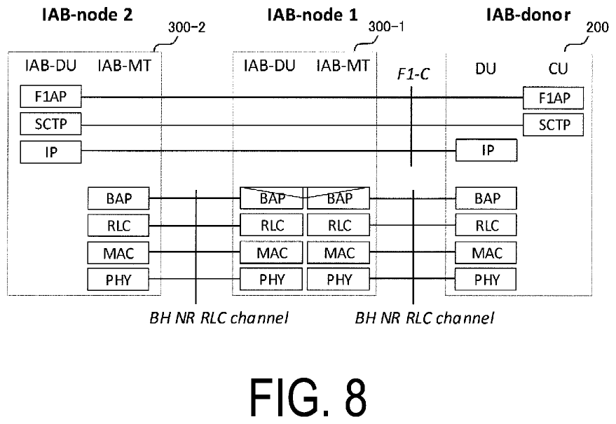

FIG. 7 is a diagram illustrating a protocol stack related to an F1-U protocol. FIG. 8 is a diagram illustrating a protocol stack related to an F1-C protocol. An example is illustrated in which the donor node 200 is divided into a CU and a DU.

As illustrated in FIG. 7, each of the IAB-MT of the IAB node 300-2, the IAB-DU of the IAB node 300-1, the IAB-MT of the IAB node 300-1, and the DU of the donor node 200 includes a Backhaul Adaptation Protocol (BAP) layer as a higher layer of the RLC layer. The BAP layer performs routing processing, and bearer mapping and demapping processing. In the backhaul, the IP layer is transmitted via the BAP layer to allow routing through a plurality of hops.

In each backhaul link, a Protocol Data Unit (PDU) of the BAP layer is transmitted by the backhaul RLC channel (BH NR RLC channel). Configuring multiple backhaul RLC channels in each BH link enables the prioritization and Quality of Service (QoS) control of traffic. The association between the BAP PDU and the backhaul RLC channel is executed by the BAP layer of each IAB node 300 and the BAP layer of the donor node 200.

Note that the CU of the donor node 200 is a gNB-CU function of the donor node 200 that terminates the F1 interface to the IAB node 300 and the DU of the donor node 200. The DU of the donor node 200 is a gNB-DU function of the donor node 200 that hosts an IAB BAP sublayer and provides a wireless backhaul to the IAB node 300.

As illustrated in FIG. 8, the protocol stack of the F1-C protocol includes an F1AP layer and an SCTP layer instead of a GTP-U layer and a UDP layer illustrated in FIG. 7.

Note that in the description below, processing or operation performed by the IAB-DU and the IAB-MT of the IAB may be simply described as processing or operation of the “IAB”. For example, in the description, transmitting, by the IAB-DU of the IAB node 300-1, a message of the BAP layer to the IAB-MT of the IAB node 300-2 is assumed to correspond to transmitting, by the IAB node 300-1, the message to the IAB node 300-2. Processing or operation of the DU or CU of the donor node 200 may be described simply as processing or operation of the “donor node”.

An upstream direction and an uplink (UL) direction may be used without distinction. A downstream direction and a downlink (DL) direction may be used without distinction.

### First Embodiment

A first embodiment will be described.

Routing and Local Routing

Firstly, routing is described.

One of the functions of the BAP layer is to route packets to the next hop. In a network including a plurality of IAB nodes 300, each IAB node 300 forwards a received packet to the next hop such that the packet is finally transmitted to the destination IAB node 300 (or the donor node 200). The routing is, for example, to control which IAB node 300 the received packet is forwarded to. Such routing is configured by the donor node 200.

However, in a network including a plurality of IAB nodes 300, a communication failure may occur in a backhaul link between the IAB nodes 300.

In a multi-hop network where packets are forwarded by a plurality of IAB nodes 300 one after another, data packets may be forwarded to a destination IAB node 300 (or donor node 200) via an alternative path. Forwarding the data packet using the alternative path in this way may be referred to as local routing. The local routing may be performed by selecting an alternative path from alternative path candidates configured by the donor node 200.

Communication in the 3GPP system is normally routed in a core network (to be specific, UPF 12). When two UEs (e.g., UE #1 (100-1) and UE #2 (100-2)) communicate with each other, even if these UEs are present in a local area (e.g., within a coverage of the same IAB node 300), data is required to be reached to the UPF 12 once and looped back to be communicated through the same path. In such a case, routing the data without involving the core network (e.g., in the IAB node 300) allows to reduce a traffic amount in the core network or reduce delay occurring in the communication in the core network. Such routing not via the core network may be referred to as local routing.

DRB Establishment and PDCP Entity Establishment

Data Radio Bearer establishment (DRB establishment) and PDCP entity establishment are described.

The DRB and the PDCP entity may be established when a PDU session is established.

A PDU session is a logical path for transferring the user data between the UE 100 and the UPF 12. The UE 100 requests the network to establish a PDU session, and thereafter, receives an RRC Reconfiguration message from the gNB 200. The RRC Reconfiguration message includes radio bearer configuration information (radioBearerConfig) for configuring the DRB. The UE 100 establishes a DRB for a new PDU session, based on the radio bearer configuration information, and generates a mapping rule for mapping a Quality of Service Flow ID (QFI) to the DRB.

The radio bearer configuration information includes DRB identification information (DRB ID) and PDCP configuration information (PDCP Config). When the UE 100 confirms that the DRB ID is not part of the current configuration in the UE 100, the UE establishes a PDCP according to the received PDCP configuration information.

After the DRB and the PDCP are established, the user data is exchanged between the UE 100 and the gNB 200 on the DRB according to the mapping rule. The user data is exchanged between the gNB 200 and the UPF 12 on a tunnel protocol of the PDU session.

In this way, the UE 100 may establish the DRB and establish the PDCP entity, based on the radio bearer configuration information included in the RRC Reconfiguration message.

Hereinafter, the DRB establishment and the PDCP entity establishment may be used without distinction.

PDCP Link

The IAB node 300 performs Layer2 Relay. Specifically, user data is relayed using layers (sublayers) below the RLC layer and the BAP layer, and layers (specifically, the PDCP layer and the SDAP layer) above these layers are not used. Therefore, there is no PDCP link between the IAB nodes 300.

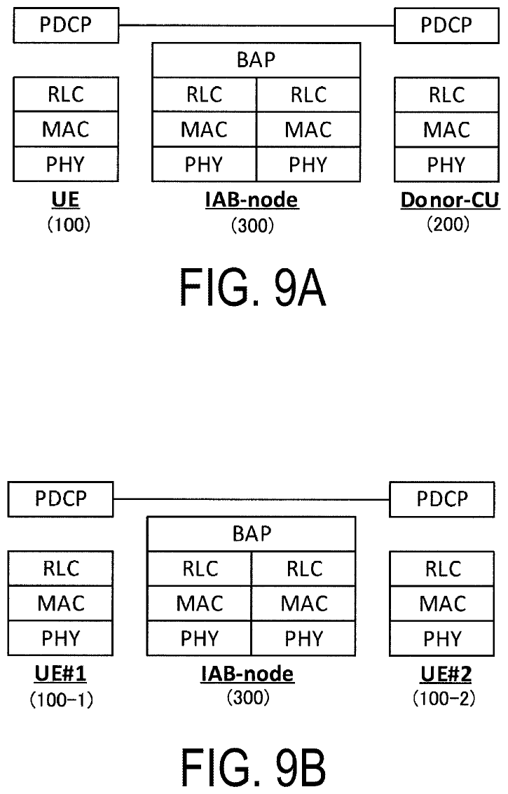

FIG. 9A is a diagram illustrating an example of a PDCP link according to the first embodiment. As illustrated in FIG. 9A, there is a PDCP link between the UE 100 and the CU of the donor node 200. However, there is no PDCP link between the UE 100 and the IAB node 300 because of the reason described above.

Therefore, even if the IAB node 300 transmits the data (PDCP PDU) transmitted from the UE #1 (100-1) to the UE #2 (100-2) through the local routing, the UE #2 (100-2) may not be able to decode the data since the PDCP link is not established. Specifically, the PDCP PDU encrypted by the UE #1 (100-1) may not be decrypted by the UE #2 (100-2).

Therefore, in the first embodiment, a PDCP link is established between the UEs 100 to exchange the data using the PDCP link.

Specifically, first, a donor node (e.g., donor node 200) performs a configuration, for each of a first user equipment and a second user equipment, to establish a data radio bearer (DRB) between the first user equipment (e.g., UE #1 (100-1)) and a second user equipment (e.g., UE #2 (100-2)). Second, the first user equipment and the second user equipment establish a first PDCP entity and a second PDCP entity, respectively, in response to the configuration. Third, the first PDCP entity transmits data to the second PDCP entity without involving a UPF (e.g., UPF 12).

As a result, a PDCP link is established between the UEs 100, and thus, even if the IAB node 300 locally routes data transmitted from the UE #1 (100-1) to transfer the data to the UE #2 (100-2), the UE #2 (100-2) can efficiently acquire the data. The local routing in the IAB node 300 allows the data transmitted from the UE #1 (100-1) to be transferred to the UE #2 (100-2) without involving the core network (e.g., UPF 12). This makes it possible to reduce a traffic amount in the core network or reduce delay occurring in the communication in the core network.

### Operation Example of First Embodiment

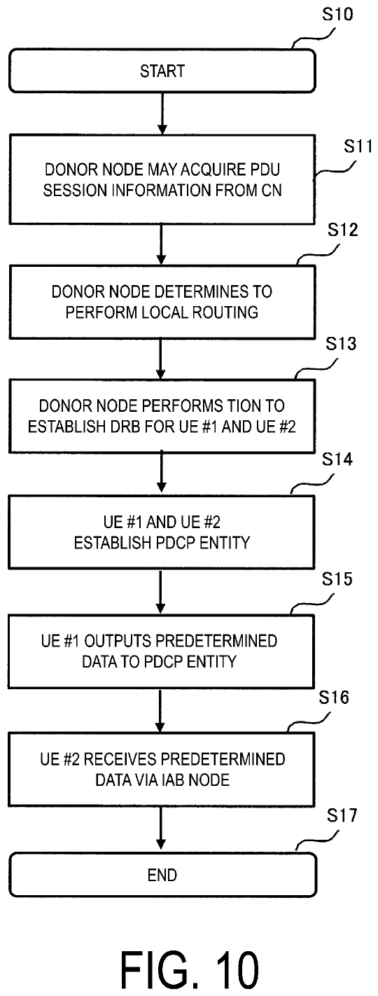

FIG. 10 is a flowchart illustrating an operation example according to the first embodiment. The operation example illustrated in FIG. 10 includes the example in which a PDCP link is established between the UE #1 (100-1) and the UE #2 (100-2).

The donor node 200 starts processing in step S10 as illustrated in FIG. 10.

In step S11, the donor node 200 may acquire information related to a PDU session capable of local routing from a CN (Core Network). The CN may be at least one of the AMF 11, the UPF 12, and the SMF 13 included in the 5GC 10.

First, for example, when data transmitted from the UE #1 (100-1) is looped backed by the UPF 12 and transmitted to the UE #2 (100-2), the donor node 200 may acquire the information related to the PDU session. Specifically, this is a case where data transmitted from the donor node 200 via a General Packet Radio Service Tunneling Protocol (GTP) tunnel is looped back by the UPF 12 and transmitted toward a different GTP tunnel of the same donor node 200.

Alternatively, for example, when the UPF 12 confirms that an IP address of the UE #2 (100-2) is present in the identical network, the donor node 200 may acquire the information related to the PDU session.

Second, the information related to the PDU session includes, for example, any one of the following.

(A1) PDU session ID: A PDU session ID between the UE 100 and the UPF 12. When the loop-back is performed by the UPF 12 as described above, a pair of a PDU session ID between the UE #1 (100-1) and the UPF 12 and a PDU session ID between the UPF 12 and the UE #2 (100-2) may be the information related to the PDU session.

(A2) GTP tunnel ID: A GTP tunnel ID between the donor node 200 and the UPF 12. When the loop-back is performed by the UPF 12 as described above, a pair of a GTP tunnel ID between the donor node 200 and the UPF 12 and a GTP tunnel ID between the UPF 12 and the donor node 200 may be the information related to the PDU session.

(A3) QoS flow ID (QFI)

(A4) IP addresses of UE 100: For example, a pair of the IP address of the UE #1 (100-1) and the IP address of the UE #2 (100-2) may be the information related to the PDU session.

(A5) UE-ID (e.g., NG-AP UE ID or 5G-S-TMSI (Temporary Mobile Subscriber Identity)): For example, a pair of the UE-ID for the UE #1 (100-1) and the UE-ID for the UE #2 (100-2) may be the information related to the PDU session.

The reason why the donor node 200 acquires the information related to the PDU session is that the information may be used in the DRB establishment or in the data transfer after the DRB establishment.

In step S12, the donor node 200 determines to perform local routing.

In step S13, the donor node 200 performs a configuration for DRB establishment for the UE #1 (100-1) and the UE #2 (100-2). For example, the donor node 200 performs the configuration for DRB establishment by transmitting an RRC Reconfiguration message including the radio bearer configuration information described above to the UE #1 (100-1) and the UE #2 (200-2).

In this case, the RRC Reconfiguration message may include information indicating that the DRB is for Peer to Peer (P2P) between the UEs. In other words, the information is information indicating that the PDCP establishment (DRB establishment) is between the UE #1 (100-1) and the UE #2 (100-2) (e.g., in FIG. 9B) and is not between the donor node 200 and the UE 100 (e.g., in FIG. 9A). The information indicating that the DRB is for Peer to Peer (P2P) between the UEs may indicate that the DRB is to be locally routed.

The RRC Reconfiguration message may include information related to the counterpart UE 100. The information includes, for example, the IP address of the UE #2 (100-2) or the UE-ID of the UE #2 (100-2).

The RRC Reconfiguration message may include a target QoS flow ID.

The RRC Reconfiguration message may include information related to the PDU session acquired by the donor node 200 in step S11.

In step S14, the UE #1 (100-1) and the UE #2 (100-2) establish a PDCP entity in response to the configuration.

For example, the UE #1 (100-1) and the UE #2 (200-2) establish the PDCP entity, based on the radio bearer configuration information (radioBearerConfig) included in the RRC Reconfiguration message. The UE #1 (100-1) and the UE #2 (200-2) may establish the PDCP entity, based on the information indicating that the DRB is for P2P and the radio bearer configuration information included in the RRC Reconfiguration message. Accordingly, as illustrated in FIG. 9B, the PDCP entity is established between the UE #1 (100-1) and the UE #2 (100-2).

Referring back to FIG. 10, in step S15, the UE #1 (100-1) outputs predetermined data to the PDCP entity (or the DRB). The predetermined data is data that matches the IP address of the UE #2. Alternatively, the predetermined data is data that matches the target QoS flow ID. Alternatively, the predetermined data is data that matches the target PDU session ID. For example, the RLC entity of the UE #1 (100-1) outputs the predetermined data to the PDCP entity as data addressed to the UE #2 (100-2). The PDCP entity of the UE #1 (100-1) transmits the predetermined data to the PDCP entity of the UE #2 (100-2). On the other hand, the RLC entity of the UE #1 (100-1) transmits data that is not the predetermined data to the RLC entity of the IAB node 300 as data addressed to the donor node 200.

In step S16, the UE #2 (100-2) receives the predetermined data via the IAB node 300 (or via the donor node 200). In other words, the PDCP entity of the UE #2 (100-2) receives the predetermined data (PDCP PDU) transmitted from the PDCP entity of the UE #1 (100-1). Note that both the UE #1 (100-1) and the UE #2 (100-2) may use a security key used in the NR Uu wireless interface as a PDCP security key.

In step S17, the UE #1 (100-1) and the UE #2 (100-2) end the series of processing operations.

### Second Embodiment

A second embodiment is described.

The first embodiment above describes the example in which after the UE #1 (100-1) and the UE #2 (100-2) establish the PDCP entity, the IAB node 300 performs the local routing to transfer the data.

The second embodiment is an embodiment regarding how local routing is performed in the IAB node 300 to transfer data.

Specifically, first, the donor node (e.g., the donor node 200) performs routing configuration for the relay node (e.g., the IAB node 300) performing local routing. Second, the relay node transmits data transmitted from a first user equipment (e.g., UE #1 (100-1)) to a second user equipment (e.g., UE #2 (100-2)) without involving a UPF (e.g., UPF 12) in accordance with the routing configuration.

Accordingly, the IAB node 300 can locally route data transmitted from the UE #1 (100-1) to appropriately transfer the data to the UE #2 (100-2) without involving the UPF 12.

Here, a general concrete example of the routing in accordance with the routing configuration is described.

### Concrete Example of Routing

In the IAB node 300, packet routing is performed, for example, as follows. Specifically, the IAB-CU of the donor node 200 provides a routing configuration to an IAB-DU of each IAB node 300. The provided routing configuration includes a routing ID and the BAP address of the next hop. The routing ID is composed of a (destination) BAP address and a path ID. Upon receiving a packet (BAP packet), each IAB node 300 reads the destination BAP address included in the header of the packet. Each IAB node 300 determines whether the destination BAP address matches its own BAP address. Each IAB node 300 determines that the data packet has reached the destination when the destination BAP address matches its own BAP address. On the other hand, each IAB node 300 forwards the packet to an IAB node 300 having the BAP address of the next hop in accordance with the routing configuration when the destination BAP address does not match its own BAP address. The routing configuration is configured by using, for example, an F1AP message.

As described above, each IAB node 300 forwards the received BAP packet to the next hop in accordance with the routing configuration provided by the donor node 200.

In the second embodiment, the donor node 200 configures the local routing by configuring a new routing ID for the IAB node 300 performing the local routing, and configuring RLC channel information associated with the routing ID. A more specific description is given below.

### Operation Example of Second Embodiment

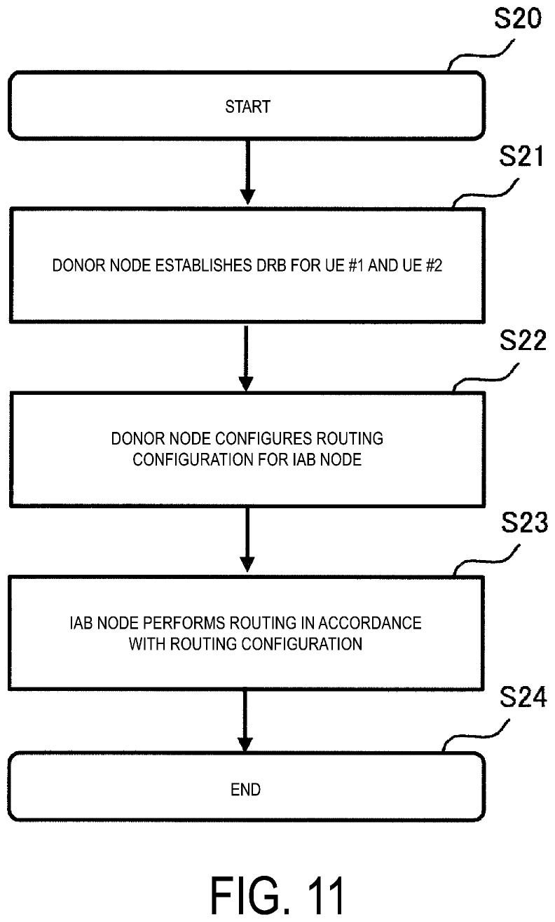

FIG. 11 is a flowchart illustrating an operation example according to the second embodiment.

The donor node 200 starts processing in step S20 as illustrated in FIG. 11.

In step S21, the donor node 200 performs a configuration to establish a DRB for the UE #1 (100-1) and the UE #2 (100-2). Step S21 is the same as step S13 in the first embodiment (in FIG. 10). Step S21 may be performed after step S23 described below.

In step S22, the donor node 200 configures routing configuration for the IAB node 300 performing local routing.

First, the donor node 200 configures a new routing ID for the IAB node 300 performing the local routing. As described above, the routing ID includes the destination BAP address. The donor node 200 may designate the BAP address of the IAB node 300 accessed by the UE #1 as the destination BAP address included in the new routing ID.

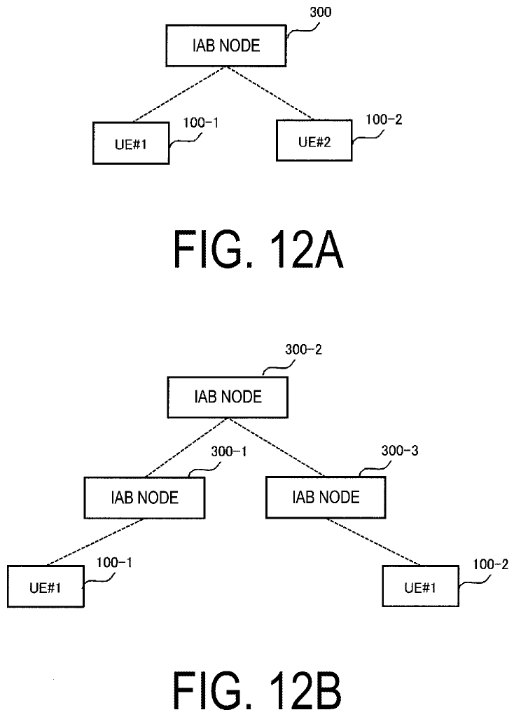

FIG. 12A is a diagram illustrating a relationship example of the IAB node 300 according to the second embodiment. In the example of FIG. 12A, the IAB node 300 accessed by the UE #1 (100-1) is also accessed by the UE #2 (100-2). In such a case, local routing is performed in the IAB node 300. The donor node 200 may use the BAP address of the IAB node 300 as the destination BAP address.

FIG. 12B is a diagram illustrating a relationship example of the IAB node 300 according to the second embodiment. In FIG. 12B, the IAB node 300-1 is accessed by the UE #1 (100-1), and an IAB node 300-3 is accessed by the UE #2 (100-2). Further, the IAB node 300-2 serves as a parent node of the two IAB nodes 300-1 and 300-3.

The donor node 200 may specifies, as the IAB node 300 performing local routing, the IAB node 300-1, the IAB node 300-2, and/or the IAB node 300-3. However, the donor node 200 may designate the BAP address of the IAB node 300-3 as the destination BAP address of the new routing ID.

In the case of FIG. 12B, in the IAB node 300-1 and the IAB node 300-2, a destination of data (BAP PDU) to be locally routed is set to the BAP address of the IAB node 300-3. Therefore, the donor node 200 may transmit, to the IAB node 300-1 and the IAB node 300-2, information indicating that the destination included in the header of the BAP PDU to be locally routed is set to the BAP address of the IAB node 300-3.

Note that the CU of the donor node 200 may transmit an F1AP message including the routing ID to the IAB-DU of the IAB node 300 to perform the configuration of the new routing ID. The CU of the donor node 200 may transmit an RRC message including the routing ID to the IAB-MT of the IAB node 300 to perform the configuration of the new routing ID.

The information indicating that the destination included in the header of the BAP PDU to be locally routed is set to the BAP address of the IAB node 300-3 may also be transmitted by way of the F1AP message or the RRC message.

Second, the donor node 200 configures RLC Channel information associated with the new routing ID to the IAB node 300 performing the local routing.

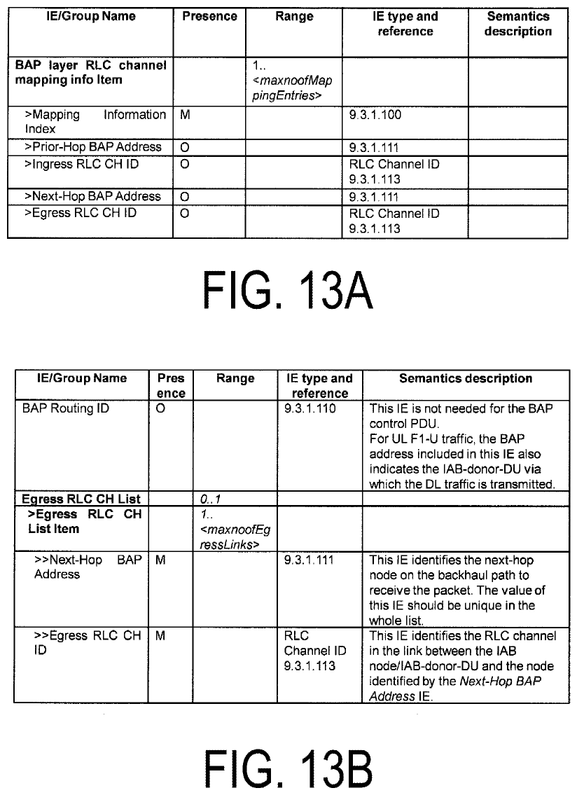

FIG. 13A is a diagram illustrating an example of the RLC channel information according to the second embodiment. The example of FIG. 13A includes a prior-hop BAP address and a next-hop BAP address. Therefore, the RLC channel information illustrated in FIG. 13A may be configured for the IAB node 300-2 illustrated in FIG. 12B, for example.

FIG. 13B is also a diagram illustrating an example of the RLC channel information according to the second embodiment. The RLC channel information illustrate in FIG. 13B includes the routing ID. Therefore, the IAB node 300 can identify the next-hop BAP address and an egress RLC CH ID from the routing ID.

However, FIGS. 13A and 13B are examples in which the RLC channel information includes the BAP address. For example, a BAP header is not added to either the input or output side of the IAB node 300 in FIG. 12A. The BAP header is not added to the input side of the IAB node 300-1 and to the output side of the IAB node 300-3 in FIG. 12B. Therefore, for example, local routing for a packet may be performed using an ingress RLC CH ID and/or an egress RLC CH ID instead of the BAP address (Prior-HOP BAP Address and Next-HOP BAP Address). The RLC channel information including an ingress RLC CH ID and/or an egress RLC CH ID without including a BAP address may be used.

The donor node 200 may also transmit association information associating the new routing ID with the RLC channel information to the IAB node 300.

Note that the CU of the donor node 200 may transmit an F1AP message including the RLC channel information to the IAB-DU of the IAB node 300 to configure the RLC channel. The CU of the donor node 200 may transmit an F1AP message including the association information to the IAB-DU of the IAB node 300. The configuration of the RLC channel and the transmission of the association information may be performed by way of an RRC message instead of the F1AP message.

Referring back to FIG. 11, in step S23, the IAB node 300 performs local routing in accordance with the routing configuration. The IAB node 300 (IAB node 300-2 in FIG. 12B) may rewrite the destination of the BAP PDU header to the BAP address of the IAB node 300-3 accessed by the UE #2 (100-2). The IAB node 300 may rewrite the path ID included in the routing ID. For each new routing ID, the donor node 200 may transmit the locally routed (or rewritten) destination BAP address (or the entire routing ID) to the IAB node 300 performing the local routing.

Then in step S24, the IAB node 300 ends the series of processing operations.

### Third Embodiment

A third embodiment is described.

The first and second embodiments above describe the examples in which the IAB node 300 performs local routing to transfer data from the UE #1 (100-1) to the UE #2 (100-2) without involving the UPF 12.

However, no data is transferred to the CN including the UPF 12. Therefore, the CN cannot grasp the data amount of the data transferred between the UE #1 (100-1) and the UE #2 (100-2).

As such, the third embodiment describes an example in which the IAB node 300 transmits a data amount of data to the donor node 200 when the IAB node 300 transfers the data through local routing. To be more specific, first, a relay node (e.g., IAB node 300) transmits data transmitted from a first user equipment (e.g., UE #1 (100-1)) to a second user equipment (e.g., UE #2 (100-2)) without involving a UPF (e.g., UPF 12) in accordance with routing configuration. Second, the relay node transmits a data amount of the data to a donor node (e.g., donor node 200).

### Operation Example of Third Embodiment

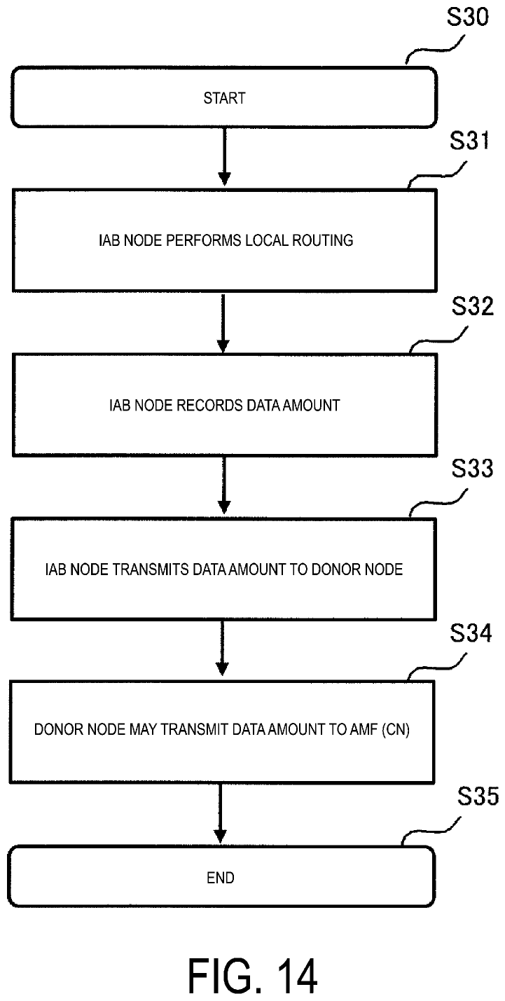

FIG. 14 is a flowchart illustrating an operation example according to the third embodiment.

The IAB node 300 starts processing in step S30 as illustrated in FIG. 14.

In step S31, the IAB node 300 performs local routing. In a manner similar to or the same as the first or second embodiment, for example, the IAB node 300 locally routes data transmitted from the UE #1 (100-1) to transmit the data to the UE #2 (100-2) without involving the UPF 12.

In step S32, the IAB node 300 counts the data amount to store (or record, hereinafter, also referred to as “store”) in a memory. The IAB node 300 may count a data amount of a payload portion of the locally routed BAP PDU to store in the memory. The IAB node 300 may count a data amount of the entire BAP PDU including the BAP header to store in the memory.

The storing may be performed in the BAP layer. In this case, for example, the BAP layer counts the data amount of the BAP PDU to store in the memory, and outputs the (cumulative) stored data amount to the RRC layer in response to a request from the RRC layer.

The storing may be performed in the RRC layer. In this case, for example, the RRC layer receives, from the BAP layer, the data amount that is counted in the BAP layer for each BAP packet transfer, and stores the cumulative data amount in the memory.

In step S33, the IAB node 300 transmits the data amount to the donor node 200. For example, the IAB node 300 reads the data amount stored in the memory and transmits the read data amount to the donor node 200.

First, the IAB node 300 may transmit at least one of the PDU session ID of the UE 100, the DRBID of the UE 100, the routing ID, and the RLC channel ID in association with the data amount.

Second, the IAB node 300 may transmit time information along with the data amount to the donor node 200. The time information may be a measurement time, a start time, an end time, or a combination thereof.

Third, the IAB node 300 may be triggered by the following to transmit the data amount to the donor node 200. Specifically, the IAB node 300 may transmit the data amount in response to a request from the donor node 200. The IAB node 300 may transmit the data amount when the configuration for the local routing is removed (e.g., in step S22 (FIG. 11) of the second embodiment). The IAB node 300 may transmit the data amount when the data amount reaches a threshold value. The threshold value may be configured by the donor node 200. The IAB node 300 may periodically transmit the data amount. A period (or time interval) may be configured by the donor node 200.

Note that the IAB-MT of the IAB node 300 may transmit an RRC message including the data amount to the CU of the donor node 200. The IAB-DU of the IAB node 300 may transmit a F1AP message including the data amount to the CU of the donor node 200.

In step S34, the donor node 200 may transmit the data amount received from the IAB node 300 to the CN including the AMF 11. In the CN, the data amount may be stored in the memory as the data amount of the user. The CN performs charging or billing processing based on the data amount.

### Other Embodiments

A program causing a computer to execute each type of processing performed by the UE 100, the gNB 200, or the IAB node 300 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing each type of processing to be performed by the UE 100, the gNB 200, or the IAB node 300 may be integrated, and at least part of the UE 100, the gNB 200, or the IAB node 300 may be configured as a semiconductor integrated circuit (a chipset or a System-on-a-chip (SoC)).

The phrases “based on” and “depending on” used in the present disclosure do not mean “based only on” and “only depending on,” unless specifically stated otherwise. The phrase “based on” means both “based only on” and “based at least in part on”. Similarly, the phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Further, any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Although embodiments have been described in detail with reference to the drawings, a specific configuration is not limited to those described above, and various design modifications and the like can be made without departing from the scope of the present disclosure. All of or a part of the embodiments can be combined together as long as no inconsistencies are introduced.

### REFERENCE SIGNS

1: Mobile communication system
10: 5GC
11: AMF
12: UPF
13: SMF
100: UE
110: Wireless communicator
120: Controller
200 (200-1, 200-2): gNB (donor node)
210: Wireless communicator
220: Network communicator
230: Controller
300: IAB node
310: Wireless communicator
320: Controller

1. A communication control method used in a cellular communication system, the communication control method comprising:
relaying, by a relay node, data between a first user equipment and a second user equipment, wherein
the relaying includes determining, by the relay node, an egress RLC channel based on identification information regarding communication between the first user equipment and the second user equipment and performing, by the relay node, the relay of a layer 2 relay by using the egress RLC channel.

2. The communication control method according to claim 1, wherein
the relay node includes a function of a user equipment.

3. A cellular communication system comprising:
a relay node;
a first user equipment; and
a second user equipment, wherein
the relay node relays data between the first user equipment and the second user equipment, and
the relay node determines an egress RLC channel based on identification information regarding to communication between the first user equipment and the second user equipment and performs the relay of a layer 2 relay by using the egress RLC channel.

4. The cellular communication system according to claim 3, wherein
the relay node includes a function of a user equipment.

5. A relay node comprising a transceiver circuitry and a processing circuitry operatively associated with the transceiver circuitry and configured to execute process of:
relaying data between a first user equipment and a second user equipment, wherein
the relaying includes determining an egress RLC channel based on identification information regarding to communication between the first user equipment and the second user equipment and performing the relay of a layer 2 relay by using the egress RLC channel.

6. The relay node according to claim 5, wherein
the relay node includes a function of a user equipment.

7. A non-transitory computer-readable storage medium storing a program for causing a computer to execute processing comprising:
relaying data between a first user equipment and a second user equipment, wherein
the relaying includes determining an egress RLC channel based on identification information regarding to communication between the first user equipment and the second user equipment and performing the relay of a layer 2 relay by using the egress RLC channel.

8. The non-transitory computer-readable storage medium according to claim 7, wherein
the relay node includes a function of a user equipment.

9. A chipset for a relay node in a cellular communication system, the chipset comprising:
relaying data between a first user equipment and a second user equipment, wherein
the relaying includes determining an egress RLC channel based on identification information regarding to communication between the first user equipment and the second user equipment and performing the relay of a layer 2 relay by using the egress RLC channel.

10. The chipset according to claim 9, wherein
the relay node includes a function of a user equipment.
